(19) United States
(12) Patent Application Publication
(10) Pub. No.: US 2007/0081082 A1
(43) Pub. Date: Apr. 12, 2007

(54) Electronic camera

(75) Inventors: Nobuyuki Watanabe, Yokohama-shi (JP); Fumiyuki Shiratani, Sagamihara-shi (JP); Hiroshi Matsuzaki, Tachikawa-shi (JP); Satoko Furuki, Utsunomiya-shi (JP); Akikazu Yachi, Hachioji-shi (JP); Hideki Nagata, Hachioji-shi (JP); Toru Matsuzawa, Kunitachi-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: OLYMPUS CORPORATION

(21) Appl. No.: 11/542,650

(22) Filed: Oct. 3, 2006

(30) Foreign Application Priority Data
Oct. 7, 2005 (JP) 2005-295235

(51) Int. Cl. H04N 5/228

(52) U.S. Cl. 348/222.1

(57) ABSTRACT

An electronic camera of the present invention has a function for photographing combined images including plural continuously photographed images. A continuous photographing mode according to a moving subject is selected by a photographing mode selection unit. A continuous photographing interval, a maximum continuous photographing number, and a number of precaptured images to be obtained are set by a system controller according to the continuous photographing mode selected by the photographing mode selection unit. When a release button is depressed, continuous photographing is carried out under the photographing conditions of the continuous photographing mode selected by the mode selection unit.

### CROSS-REFERENCE TO RELATED APPLICATIONS

This application is based upon and claims the benefit of priority from prior Japanese Patent Application No. 2005-295235, filed Oct. 7, 2005, the entire contents of which are incorporated herein by reference.

### BACKGROUND OF THE INVENTION

1. Field of the Invention

The present invention relates to an electronic camera, and more particularly, to an electronic camera that can continuously photograph plural images.

2. Description of the Related Art

Electronic cameras can carry out not only independent photographing but also continuous photographing of plural images and photographing of a moving picture. A desired subject can be obtained without missing a shutter chance by carrying out the continuously photographing. Note that plural images photographed by the continuous photographing are called combined pictures. Further, Jpn. Pat. Appln. KOKAI Publication Nos. 2002-252804 and 2002-290904, for example, disclose electronic cameras having a precapture function for recording time-sequential precaptured images until just before a predetermined manipulation, based on which a user carries out photographing, is carried out together with a finally photographed image.

### BRIEF SUMMARY OF THE INVENTION

Incidentally, in the continuous photographing, the number of sheets of necessary images is different depending on a subject. When, for example, “a still subject”, “a walking person”, and the like in which a subject little moves, are photographed, they little change between frames. Accordingly, a shutter chance is not missed in the continuous photographing even if a camera is set (a) to increase an interval between frames, (b) to reduce the number of sheets of images to be photographed, or (c) to reduce the number of precaptured images. Inversely, when these continuous photographing conditions are not set properly to a target to be photographed, that is, when the interval between frames is excessively short, when the number of sheets of images to be photographed is excessively large, or when the number of precaptured images is excessively large, many photographs having a similar composition are wastefully taken eventually, thereby a lot of power and a storage capacity may be consumed, and a job for selecting photographed images, and the like may be troublesome and time consuming.

In contrast, when subjects such as “sport”, “a train”, “a vehicle” and the like, which greatly move and thus images greatly change between frames, are photographed, it is necessary that the camera is set (a) to reduce the interval between frames, (b) to increase the number of sheets of images to be photographed, and (c) to increase the number of precaptured images so that a shutter chance is not missed. Unless these continuous photographing conditions are properly set to the subjects to be photographed, the shutter chance may be missed.

As described above, it is preferable to change the settings of continuous photographing depending on a subject to be photographed.

Accordingly, an object of the present invention is to provide an electronic camera which can prevent, when a plurality of continuous images are photographed, a shutter chance from being missed due to an insufficient number of sheets of photographed images as well as which can prevent a memory and power from being wastefully consumed and can reduce a troublesome manipulation for obtaining desired images from an unnecessarily large number of sheets of photographed images because an excessively large number of sheets of images are photographed and recorded on the contrary.

In an electronic camera of the present invention having a plurality of photographing modes and a continuously photographing function for photographing a plurality of continuous images, a feature of the electronic camera resides in that it comprises a mode selection unit which selects any one of the plurality of photographing modes and a condition setting unit which sets a continuous photographing conditions according to the photographing mode selected by the selection unit.

### BRIEF DESCRIPTION OF THE SEVERAL VIEWS OF HE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an upper view showing an outside arrangement of an electronic camera according to the present invention.

FIG. 2 is a block diagram showing a schematic arrangement of the electronic camera according to the present invention.

FIG. 3 is a view explaining various modes marked to a photographing mode selection dial 22 of FIG. 1.

FIG. 4 is a flowchart explaining a continuously photographing mode selecting operation of an electronic camera in an embodiment of the present invention.

### DETAILED DESCRIPTION OF THE INVENTION

An embodiment of the present invention will be described below with reference to the drawings.

FIG. 1 is an upper view showing an outside appearance of an electronic camera according to the present invention.

In FIG. 1, a camera body 10, to which a grip portion is formed, has a lens barrel 12 mounted on it, and a photographing lens 26 is accommodated in the lens barrel 12. A release button 14 is disposed in a front portion of the grip portion of the camera body 10 to carry out a photographing operation of the camera. Further, a mode selection dial 22 is disposed on an upper surface portion of the camera body 10 so as to be rotated in the direction of an arrow A in the figure about a shaft 16. The mode selection dial 22 is a mode selection means for setting various modes as to photographing (photograph modes). A photographing mode selected by the mode selection dial 22 is determined by setting the mark of the mode to a mode determining position 18 disposed to the camera body 10.

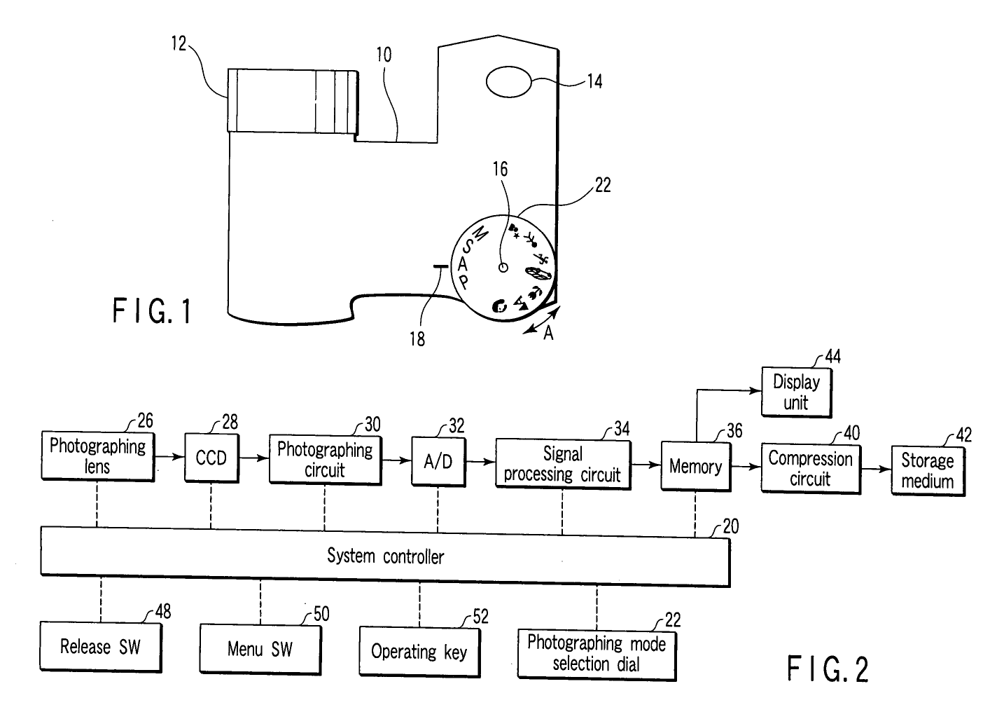

FIG. 2 is a block diagram showing a schematic arrangement of the electronic camera according to the present invention.

In FIG. 2, a system controller 20 controls the operation of the electronic camera in its entirety and is composed of a CPU and the like. The system controller 20 has a function as a change means (setting means) for changing or setting photographing conditions such as shutter speed, a diaphragm, a gain, and the like according to a photographing mode selected by the mode selection dial 22 described above.

Then, connected to the system controller 20 are the photographing lens 26 accommodated in the lens barrel 12, a CCD 28 as an image pick-up element for imaging the optical image of a subject through the photographing lens 26, a photographing circuit 30 for converting the optical image captured by the CCD 28 to an electrical signal, an analog-to-digital converter 32, a signal processing circuit 34, and a memory 36.

Further connected to the system controller 20 are a release switch (SW) 48, which corresponds to the release button 14, to start the photographing operation, a menu switch (SW) 50 for manipulating the various functions of the electronic camera, a manipulation key 52 corresponding to manipulation buttons necessary to manipulate the camera, and the photographing mode selection dial 22 described above. Further, a compression circuit 40, a storage medium 42, and a display unit 44 are connected to the memory 36.

The release switch 48 corresponds to the release button 14 described above and is composed of a two-stage switch having a first release switch and a second release switch. When the release button 14 is depressed half, the first release switch is turned on, and a photographing preparation operation such as a light metering processing, a distance measuring processing, and the like are carried out. Further, when the release button 14 is entirely depressed, the second release switch is turned on, and an exposing operation is carried out.

An image to be photographed begins to be buffered in response to the turn-on of the first release switch, and an instruction for photographing is accepted in response to the turn-on of the second release switch. Accordingly, an image is finally photographed as well as a series of images composed of a predetermined number of precaptured images and the finally photographed image begin to be recorded. The precaptured images are preparatory images that are sequential in time until just before the second release switch is depressed.

Further, the precaptured images are obtained by recording the images, which were buffered in the memory 36 from the timing at which the first release switch was turned on to the timing at which the second release switch was turned on, to the storage medium 42. The finally photographed image is obtained by recording the images, which were buffered in the memory 36 during the time in which the first release switch was turned on after the timing at which it was turned on, to the storage medium 42. Note that when optical images are read out from the CCD 28 at an interval of 15 times per second, the images are buffered in the memory 36 with an upper limit of 15 images per second.

Note that since the photographing lens 26, the CCD 28, the photographing circuit 30, the analog-to-digital converter 32, the signal processing circuit 34, the memory 36, the compression circuit 40, the storage medium 42, and the display unit 44 described above are known well, the detailed explanation thereof is omitted.

In the above arrangement, the optical image of a not shown subject passing through the photographing lens 26 is converted into the electrical signal by the CCD 28 and further converted into an analog image signal by the photographing circuit 30. After the analog image signal is converted into a digital image signal (hereinafter, also referred to as “image information”) by the analog-to-digital converter 32, the image information is subjected to a color information conversion processing, a number of pixels conversion processing, and the like in the signal processing circuit 34. Then, the image information subjected to the various image processings in the signal processing circuit 34 is stored in the volatile memory 36. The memory 36 is composed of a high-speed storage means, for example, an SDRAM and used also as an image processing work area to be described later.

The image information stored once in the memory 36 is, for example, JPEG compressed in the compression circuit 40 and stored in the storage medium 42 such as a smart medium and the like. Further, the image information having been subjected to the signal processing is displayed on the display unit 44 from the memory 36 through a not shown drive circuit.

Note that when an image stored in the storage medium 42 is displayed, the stored image is extended in a not shown extension circuit, subjected to a predetermined image processing in, for example, the signal processing circuit 34 and then displayed on the display unit 44 likewise a photographed image.

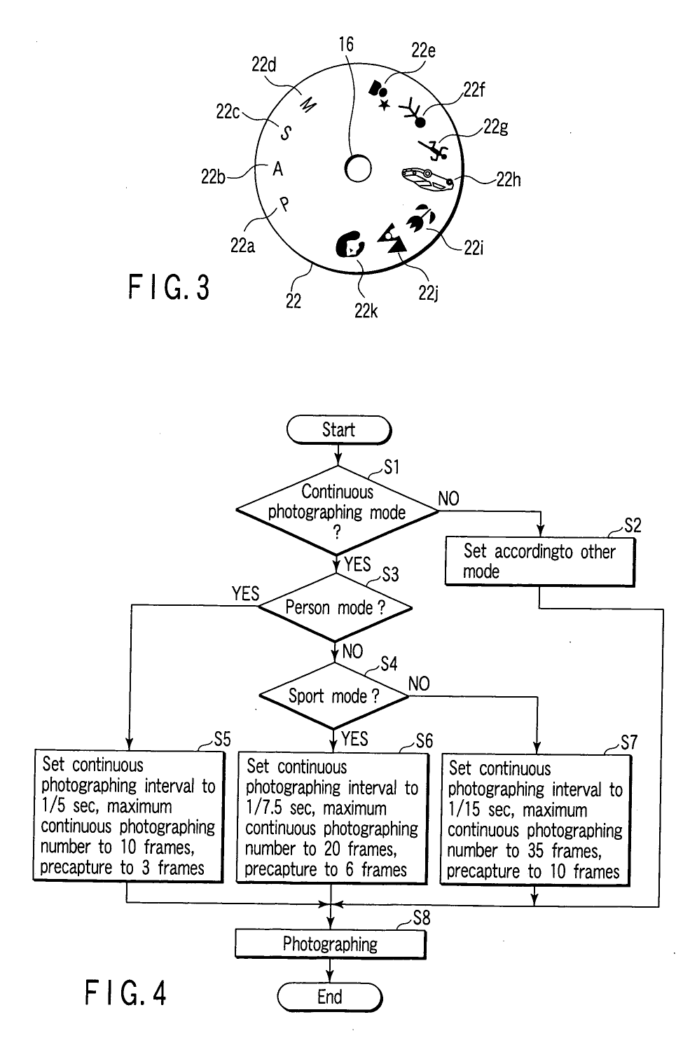

FIG. 3 is a view explaining various modes marked to the photographing mode selection dial 22.

In FIG. 3, a mark 22a shows a program mode, and a mark 22b shows an exposure priority mode. Further, a mark 22c shows a shutter speed priority mode, and a mark 22d shows a manual mode. Likewise, a mark 22e shows a night scene photographing mode suitable for photographing a night scene.

The marks 22f to 22h show continuous photographing modes for continuously photographing plural images, and a shutter speed is previously determined by a program. Among them, the mark 22f shows a continuous photographing mode suitable to a case in which a subject (to be photographed) is a walking person, and the mark 22g is a mark showing a continuous photographing mode suitable for a case in which a subject is a person promptly moving in sport and the like. Further, the mark 22h is a mark showing a continuous photographing mode suitable for a vehicle such as a car and the like.

Further, a mark 22i shows a close-up mode suitable for close-up photographing, a mark 22j shows a distant landscape mode suitable for photographing of a distant landscape, and a mark 22k shows a portrait mode suitable for photographing of a portrait.

Next, a continuous photographing mode selecting operation of the electronic camera according to the embodiment of the present invention will be explained with reference to a flowchart of FIG. 4.

When a not shown power switch is turned on, first, in step S1, it is determined whether or not the photographing mode of the camera is a continuous photographing mode. This is determined by whether any of the marks 22f to 22h in FIG. 3 showing the continuous photographing modes is set to the mode determining position 18. When a mode other than the continuous photographing modes is set here, that is, when any of the marks 22a to 22e or the marks 22i to 22k is selected, the process goes to step S2, and the photographing conditions of the photographing mode corresponding to the mark are set. Thereafter, the process goes to step S8 to be described later.

In contrast, when a continuous photographing mode is selected in step S1, the process goes to step S3, and whether or not the continuous photographing mode is the person mode described above is determined by the setting of the mark 22f. When it is determined here that the continuous photographing mode is not the person mode, the process goes to step S4, and whether or not the sport mode described above is selected is determined.

When the person mode is selected in step S3, that is, when the mark 22f of the photographing mode selection dial 22 is set to the mode determining position 18, the process goes to the person mode in step S5. In the person mode, when a continuous photographing interval is set to ⅕ second, a maximum continuous photographing number is set to 10 frames as the photographing conditions and the second release switch is turned on, the number of precaptured continuous images, which are obtained during a period of time until just before an instruction for continuous photographing is accepted, is set to three frames.

Note that the continuous photographing interval means a time interval of timings at which respective images, which are obtained in the continuous photographing carried out once by turning on the second release switch once, are photographed. In the embodiment, the respective precaptured images are also obtained at the continuous photographing interval. Further, in the embodiment, a period of time from a time at which a first image begins to be photographed to a time at which a next image begins to be photographed is set as the continuous photographing interval. However, the continuous photographing interval is not limited to that of the embodiment, and a period of time from a time at which photographing of a first image is finished to a time at which a next image begins to be photographed may be set as the continuous photographing interval, and a period of time from a time at which photographing of a first image is finished to a time at which photographing of a next image is finished may be set as the continuous photographing interval. Further, the maximum continuous photographing number means a maximum number of images obtained in the continuous photographing carried out once by turning on the second release switch once. That is, even if a state, in which the release button 14 is continuously depressed, is detected by the turned-on state of the second release switch, the number of images exceeding the maximum continuous photographing number is not recorded to the recording medium 42.

Further, when the sport mode is selected in steps S3 and S4, that is, when the mark 22g of the photographing mode selection dial 22 is set to the mode determining position 18, the process goes to step S6. In the sport mode, the continuous photographing interval is set to 1/7.5 second, the maximum continuous photographing number is set to 20 frames, and the number of precaptured images to be obtained is set to 6 frames as the photographing conditions. Further, when the vehicle mode, which is neither the person mode nor the sport mode, is selected in steps S3 and S4, (when the mark 22h of the mode selection dial 22 is set to the mode determining position 18), the process goes to step S7. In the vehicle mode, the continuous photographing interval is set to 1/15 second, the maximum continuous photographing number is set to 35 frames, and the number of precaptured images to be obtained is set to 10 frames as the photographing conditions.

Note that, in the respective continuous photographing modes at steps S5, S6, and S7 of the embodiment, the continuous photographing interval, the maximum continuous photographing number, and the number of precaptured images as the respective photographing conditions are previously determined when the electronic camera is shipped, and the like. However, they are not limited to those previously determined in the embodiment, and a user may previously set the continuous photographing interval, the maximum continuous photographing number, and the number of precaptured images to values of his/her choice.

Then, in step S8, predetermined photograph processings are carried out according to a photographing mode set in steps S1 to S4 described above. That is, when a mode other than the continuous photographing modes is selected, photographing is appropriately carried out in an exposure time according to a photographing mode set in step S2. In contrast, when a continuous photographing mode in steps S5, S6, and S7 is selected, an exposure time is determined according to the continuous photographing interval, the maximum continuous photographing number, and the number of precaptured images selected in steps S5, S6, and S7, and photographing is carried out continuously (continuous photographing).

When, for example, an optical image can be read from the CCD 28 at an interval of 15 times per second and the continuous photographing interval is set to 1/15 second, the maximum continuous photographing number is set to 10 frames, and the number of precaptured images to be obtained is set to 3 frames, it is contemplated that this is (the person mode described above).

In this case, optical images are read repeatedly from the CCD 28 at an interval of 1/15 second from the timing at which the first release switch was turned on, and precaptured images are buffered in the memory 36 every time the optical images are read three times, that is, at an interval of ⅕ second. Then, at the timing at which the second release switch is turned on, three latest precaptured images, which are selected from the precaptured images buffered until that time and finally photographed images photographed at an interval of ⅕ second after the above timing are stored in the storage medium 42 as continuously photographed images. At the time, even if a state, in which the release button 14 is continuously depressed, is detected by the turned-on state of the second release switch, the number of images exceeding 10 frames that is the maximum continuous photographing number is not stored in the storage medium 42. The continuously photographed images are obtained based on the continuous photographing interval, the maximum continuous photographing number, and the number of precaptured images to be obtained according to the respective photographing modes.

Accordingly, in the continuous photographing mode in which a subject is a person moving slowly (person mode), the continuous photographing interval is increased and the maximum continuous photographing number and the number of precaptured images are reduced as compared with the continuous photographing mode in which a subject is a person playing sport (sport mode) and with the continuous photographing mode in which a subject is a vehicle (vehicle mode). As a result, the number of images to be photographed is not wastefully increased. Further, in the sport mode and the vehicle mode in which a subject moving promptly is photographed, the continuous photographing interval is reduced and the maximum continuous photographing number and the number of precaptured images are increased as compared with the person mode. As a result, it can be prevented that an insufficient number of pictures are photographed and a shutter chance is missed.

Moreover, since the continuous photographing interval, the maximum continuous photographing number, and the number of precaptured images of the respective continuous photographing modes are previously set, a user can carry out an intended continuous photographing (photographing of combined images) only by selecting a corresponding continuous photographing mode with the photographing mode selection dial 22 according to how promptly a subject moves, and thus operability can be also improved.

As the photographing conditions of the embodiment described above, the continuous photographing interval is set to ⅕ second, the maximum continuous photographing number is set to 10 frames, and the number of precaptured images to be obtained is set to 3 frames in the person mode, the continuous photographing interval is set to 1/7.5 second, the maximum continuous photographing number is set to 20 frames, and the number of precaptured images to be obtained is set to 6 frames in the sport mode, and the continuous photographing interval is set to 1/15 second, the maximum continuous photographing number is set to 35 frames, and the number of precaptured images to be obtained is set to 10 frames in the vehicle mode. However, the continuous photographing conditions are not limited to those described above as long as they can be changed according to the speed of a moving subject.

Further, in the embodiment described above, although the person mode, the sport mode, and the vehicle mode are described as the photographing modes for carrying out the continuously photographing, they are not limited to the above modes. In short, it is sufficient to provide plural types of continuous photographing modes and to carry out the continuous photographing under the continuous photographing conditions according to the respective photographing modes in consideration of the characteristics of a photographing scene (subject) to be photographed in the respective photographing modes. In the embodiment described above, the continuous photographing interval, the maximum continuous photographing number, and the number of precaptured images to be obtained are described as the continuous photographing conditions. However, the continuous photographing conditions are not limited to the above conditions, and it is also possible to carry out the continuous photographing by changing conditions, for example, shutter speed, a diaphragm, and the like according to a photographing mode.

Further, it is not always necessary to change all the continuous photographing conditions according to a photographing mode, and some of the continuous photographing conditions may be the same in some photographing modes. That is, the continuous photographing conditions to the respective photographing modes can be changed by changing at least one of the continuous photographing interval, the maximum continuous photographing number, and the number of precaptured images according to a photographing mode. At this time, when the numbers of precaptured images are caused to be in agreement with each other in the respective photographing modes, the number of the precaptured images may be one image or a plurality of images. However, the precaptured images can be effectively obtained according to a target to be photographed without being wasted by setting the continuous photographing interval and the number of sheets of precaptured images according to the prescribed photographing modes as in the embodiment.

For example, the start time of the continuous photographing may be changed according to a subject (photographing mode) by setting the continuous photographing interval to a given interval and adaptably changing the number of precaptured images to be obtained.

Note that the start time of the continuous photographing means timing at which a continuously photographing image is photographed, and, in the embodiment, means the period until a first image, which is recorded as a continuously photographed image, is photographed going back from the time at which the second release switch is turned on. In other words, when the start time of the continuous photographing is shown by T, the number of precaptured images to be obtained is shown by N, and the continuous photographing interval is shown by I, the start time of the continuous photographing is approximately shown by T=N×I, although it is made to fluctuate somewhat by the timing of reading from the CCD 28 and the timing at which the second release switch is turned on.

Although the embodiment of the present invention has been described, the present invention can be variously modified within the scope that does not depart from the spirit of the invention in addition to the embodiment described above.

According to the present invention, there can be provided the electronic camera arranged such that when plural images are continuously photographed, manipulation is not troublesome, and a shutter chance is unlikely to be missed by wastefully carrying out photographing or by photographing an insufficient number of images.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. An electronic camera having a plurality of photographing modes and a continuous photographing function for continuously photographing a plurality of images, comprising:
a mode selection unit which selects a photographing mode from said plurality of photographing modes; and
a condition setting unit which sets a continuous photographing condition according to the photographing mode selected by the mode selection unit.

2. The electronic camera according to claim 1, wherein the continuous photographing condition set by the condition setting unit is at least one of the number of the images to be obtained by the continuous photographing, the photographing interval of the images to be obtained by the continuous photographing, and the start time of the continuous photographing.

3. The-electronic camera according to claim 1, wherein the continuous photographing function is accepting an instruction for carrying out continuous photographing, and storing captured images that are images obtained by photographing carried out after the instruction is accepted and precaptured images that are images obtained by photographing carried out before the instruction is accepted.

4. The electronic camera according to claim 3, wherein the continuous photographing condition set by the condition setting unit is at least one of the number of the images to be obtained by the continuous photographing including the recorded number of the precaptured images, the photographing interval of the images including the precaptured image obtained by the continuous photographing, and the start time of the continuous photographing carried out before the instruction is accepteed.
